(19) United States
(12) Patent Application Publication
(10) Pub. No.: US 2026/0314574 A1
(43) Pub. Date: Oct. 15, 2026

(54) Fish Stringer Clip

(71) Applicant: Chris Hempel, Austin, TX (US)

(72) Inventor: Chris Hempel, Austin, TX (US)

(21) Appl. No.: 19/466,391

(22) Filed: Jan. 31, 2026

Related U.S. Application Data
(60) Provisional application No. 63/752,065, filed on Jan. 31, 2025.

(51) Int. Cl. A01K 65/00

(52) U.S. Cl. CPC A01K 65/00

(57) ABSTRACT

A double-back latch fish stringer clip allows a fisherman to secure and release a fish stringer with one hand. The fish stringer needle is inserted into the fish stringer clip from a first end, passes through the fish stringer clip, and then is inserted into the fish stringer clip from the other end. The rigidity of the needle prevents it from being pulled out of the clip when the string is pulled from the first end.

### TECHNICAL FIELD OF THE INVENTION

The present invention relates to a device to facilitate securing a fish stringer while fishing.

### BACKGROUND OF THE INVENTION

Fishermen use a fish stringer to keep previously caught fish. The stringer with the fish can be kept in water to keep the fish alive while continuing to fish. One common type of stringer comprises a needle and a string connected at one end to a needle. FIG. 1 shows a typical fish stringer 100. When a fish is caught, a needle 102 is threaded through the fish's gill or mouth to attach the fish to a string 104. An obstruction, such as a float 106 or ring clip, positioned at the end of the string 104 opposite the end with the needle 102, prevents the fish from sliding off the string at the end opposite the needle 102. The obstruction may be removable to allow the fish to be removed from the end of the stringer opposite the needle. The diameter of the needle portion and the string will vary with the type of fish being caught. A larger fish species requires a thicker needle and stronger line. Attaching a fish to such stringers typically requires two hands, which can be awkward when the angler is also holding a fishing rod or wading, one hand hold to the needle and one hand to hold the fish. This can be awkward while also holding a fishing rod and wading in water.

Other types of stringers use clips attached to a chain or cable, with the fish being attached to the clips instead of directly on the main line.

U.S. Pat. No. 10,524,457 to Power for a “Fish Stringer Assembly” shows an example of a device for securing a fish stringer. In the device of Power, a catch at 90 degrees to channel is used to secure the stringer. The device of Power uses a single channel with no separator within the channel and in operation, the needle is not passed through the channel. The channel in Powers includes drain holes to allow water to leave the device.

FIG. 2 shows a fish stringer 150 from ForEverlast in Hallettsville, Texas, which includes a float 152, a string 156, and a first needle 154 attached to a first end of the string 156. Float 152 includes a hole 158 in the center and a smaller, blind, offset hole 160. The string 156 includes a second needle 162 attached to second end of string 156. One end of the string 156 is secured to the float by passing the string 156 through the hole 158 and then inserting the string 158 into the blind hole 160. The other end of the string with first needle 154 remains unsecured.

### SUMMARY OF THE INVENTION

An object of the invention is to provide a method and apparatus for facilitating the use of a needle-type fish stringer.

The invention provides a double-back latch system that can be operated using one hand to secure the fish stringer needle as well as the caught fish on the stringer.

A housing includes a separator. The needle is inserted from below through the housing on one side of the separator and then inserted into the housing from above on the opposite side of the separator. The separator redirects the force applied to the string such that pulling downward on the string urges the needle upward and laterally toward the separator instead of just pulling the needle downward and out of the housing. The dimensions of the housing and the separator relative to the needle constrain the relatively rigid needle to stay in the housing.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a prior art fish stringer;

FIG. 2 shows another prior art fish stringer;

FIG. 3 shows a fish stringer clip in accordance with this disclosure;

FIG. 4 shows the fish stringer clip of FIG. 3 from a different angle in which the attachment clip is visible;

FIG. 5 shows the fish stringer clip of FIG. 3 without the attachment clip with threaded holes for attaching an attachment clip;

FIG. 6 is a flow chart showing a method of using the fish stringer clip of FIG. 3.

FIG. 7 shows an angler performing one step of the method of FIG. 6;

FIG. 8 shows an angler performing another step of the method of FIG. 6;

FIG. 9 shows an angler performing another step of the method of FIG. 6;

FIG. 10 shows another fish stringer clip in accordance with this disclosure; and

FIG. 11 shows another fish stringer clip in accordance with this disclosure.

### DETAILED DESCRIPTION OF PREFERRED EMBODIMENTS

A fish stringer clip is designed to be used with needle-type fish stringers. The double-back latch system provides safe and secure containment of the fish stringer tip as well as of the caught fish on the stringer. With no moving parts, the simple design provides ease of use and eliminates the need for knots and snap clips. An optional attachment clip facilitates securely mounting the fish stringer clip to a belt, such as on pants or waders. Having the fish stringer clip securely mounted to an object, such as the angler or his equipment, allows one handed attachment of a fish to the stringer.

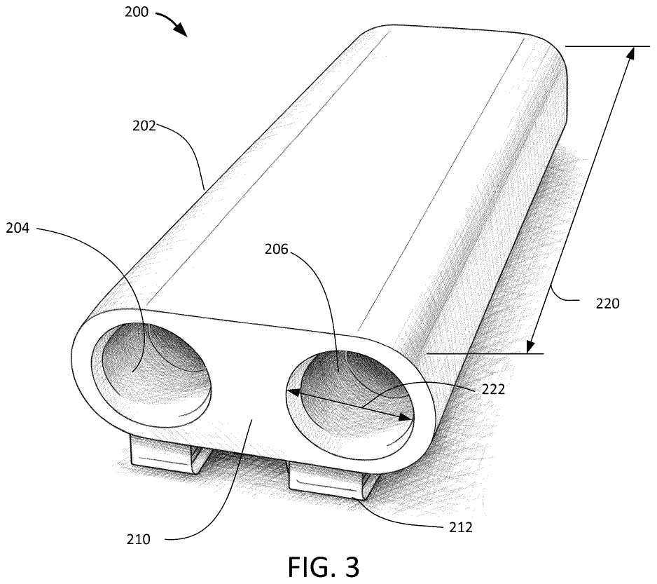

A fish stringer clip 200 as shown in FIG. 3 shows a housing 202 that includes a first cylindrical channel 204 and a second cylindrical channel 206. In the fish stringer clip shown, the housing 202 comprises a solid block through which first cylindrical channel 204 and second cylindrical channel 206 extend. First cylindrical channel 204 and the second cylindrical channel 206 typically extend all the way through housing 202. The first cylindrical channel 204 and a second cylindrical channel 206 are separated by a separator 210, which as shown consists of the solid portion of housing 202 between the first cylindrical channel 204 and a second cylindrical channel 206. An attachment clip 212 facilitates attaching fish stringer clip 200 to a belt or to equipment, such as a boat. The housing can be made from any suitable material, such as a polymer, stainless steel, or aluminum. Attachment clip 212 is adapted to clip to a belt but can be removed and different attachment clips for attaching to different objects, can be attached to the fish stringer clip 200. The attachment clips can be interchangeable to attach the fish stringer clip to different objects.

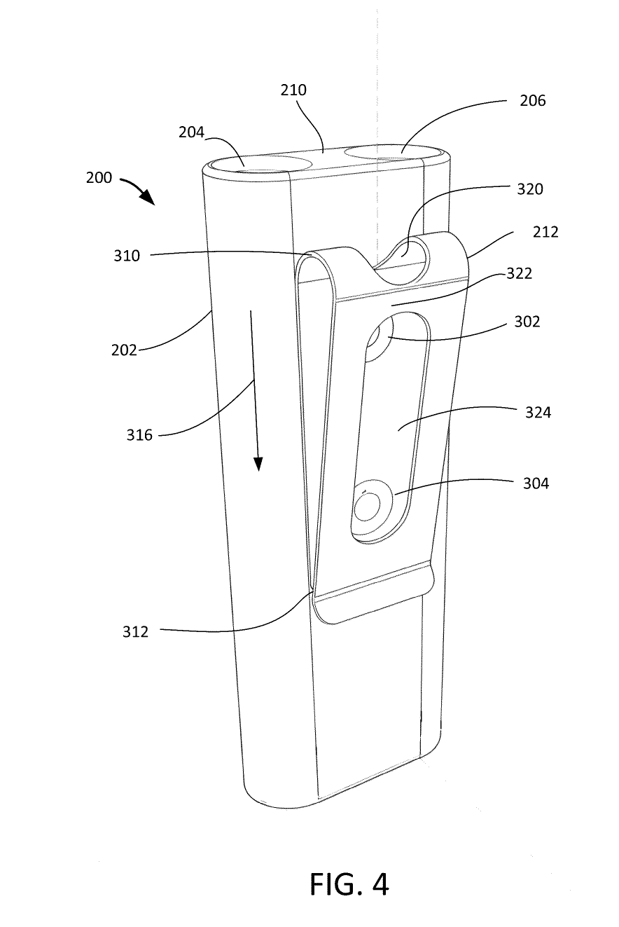

FIG. 4 shows another view of the fish stringer 200 with the attachment clip 212 more visible. Two connectors 302 and 304 secure the attachment clip 212 to the housing 202. Connectors 302 and 304 can be, for example, screws, bolts or rivets. Connectors 302 and 304 preferably do not extend past the interior surface of clip 212 to avoid abrading the belt and may be, for example, screws that are countersunk so that the heads do not protrude.

Clip 212 is preferably made of a springy material and includes a closed top 310 and a bottom 312 that is held closed by tension but that can be opened for insertion of a belt or other object to clip the fish stringer 200 to the belt or object. The long axes of channels 204 and 206 are parallel to the direction 316 between bottom 312 and top 310. That is, the clip 212 is attached to a belt by moving the clip in the direction 316 onto the belt so that the belt moves into the clip in a direction parallel to the long axes of channels 204 and 206.

Clip 212 includes an opening 324 in the portion of the clip spaced away from the housing and another opening 320 at the top of the clip. A solid portion 322 extends between the opening 320 and the opening 324. Opening 320 forms a hook eye to which, for example, a carabiner can be attached to attach the fish stringer clip 200 to another object when not being attached to a user's belt with clip 212. When a carabiner is attached through opening 320, solid portion 322 prevents the carabiner from sliding down opening 324, which could result in fish stringer clip 200 turning upside down and allowing the needle fall out of the channel. Fish stringer clip 200 is referred to as a double-back latch system because the needle is inserted into the fish stringer clip from one end, passes through the fish stringer clip, and then is inserted into the fish stringer clip from the other end.

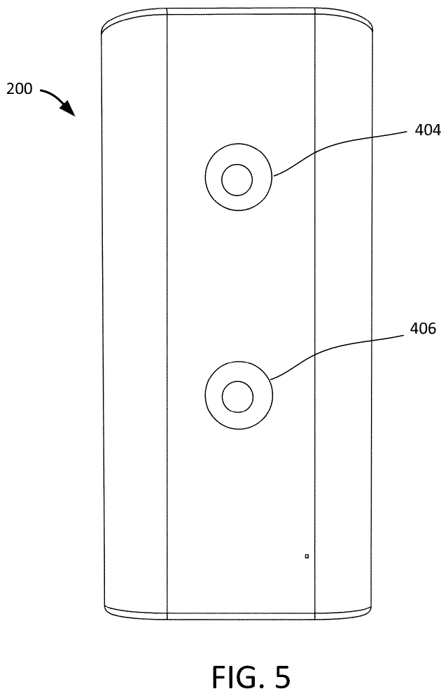

FIG. 5 shows the fish stringer clip 200 without the attachment clip 212 and shows countersunk threaded holes 404 and 406 into which connectors 302 and 304 can be threaded to secure attachment clip 212 to the housing 202.

A fish stringer clip in accordance with this disclosure may include any type of attachment clip to attach the fish stringer clip to the user, for example, to the user's belt or vest, or to the user's equipment, such as to a kayak or other boat. Many types of clips are known and can be used with the fish stringer clip described here. The fish stringer clip can optionally be used without an attachment clip, typically with a separate holder or case that is attached to the user or to the user's equipment, and into which the fish stringer clip can be inserted or attached.

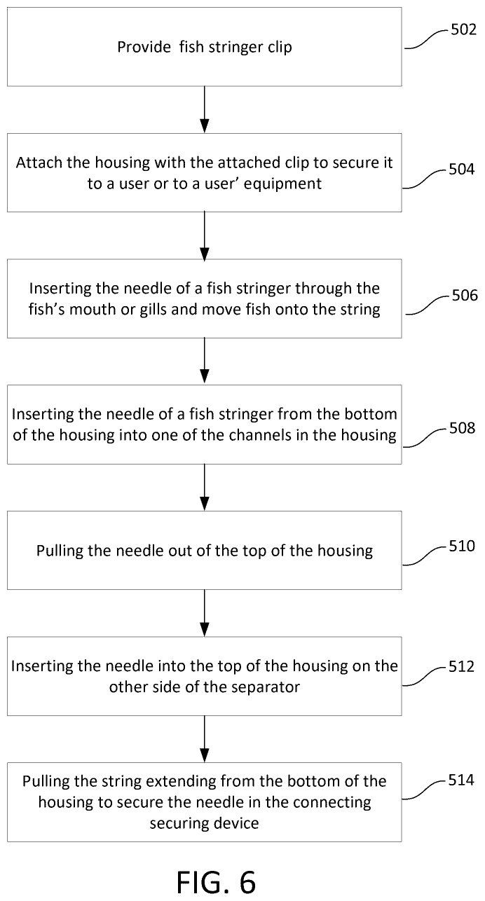

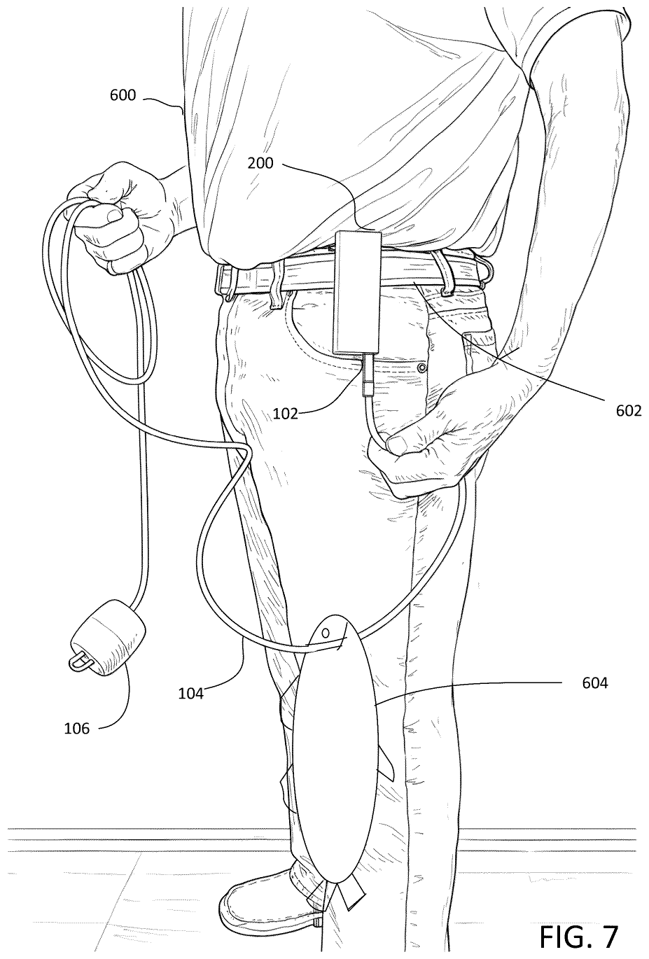

FIG. 6 is a flow chart showing the steps of using a fish stringer clip of the present disclosure. A fish stringer clip is provided in step 502. In step 504, the fish stringer clip is attached to a user, such as to a belt or vest, or to a user's equipment, such as a boat. In step 506, after a fish is caught, the needle of the stringer is inserted into the mouth or gills of the fish, and the fish is moved along the string to make room for additional fish as is conventional in the use of fish stringers. After stringing a fish by inserting the needle through the gills or mouth of the fish and moving the fish onto the string, in step 508, the user inserts the needle from the bottom of the fish stringer clip up through the housing, such as a first channel in the housing. FIG. 7 shows an angler 600 with a fish stringer clip 200 attached to his belt 602 and a fish 604 on the string 104 of a fish stringer. The angler is inserting the needle 102 of the fish stringer from the bottom of the fish stringer clip through a channel in the housing. In step 510, the user pulls the string 104 from the top of the fish stringer clip 200.

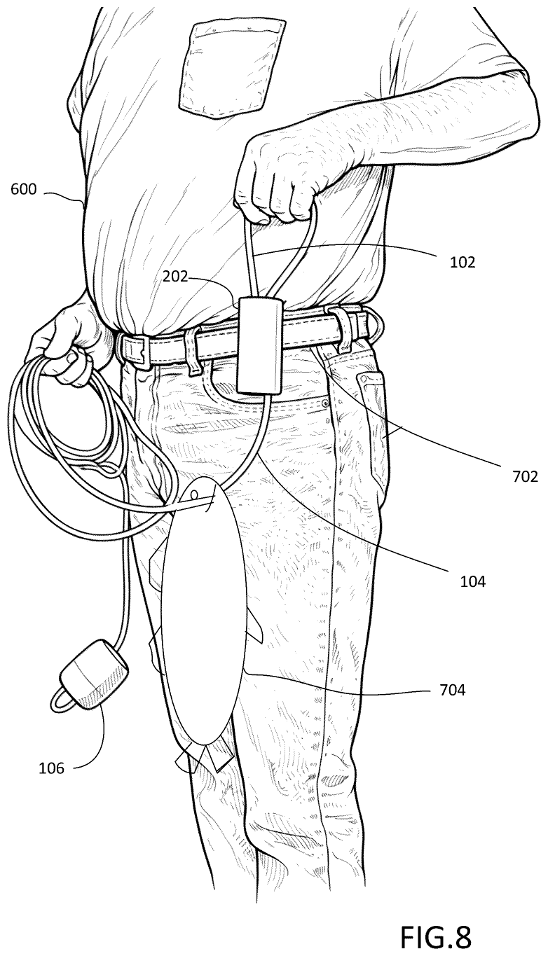

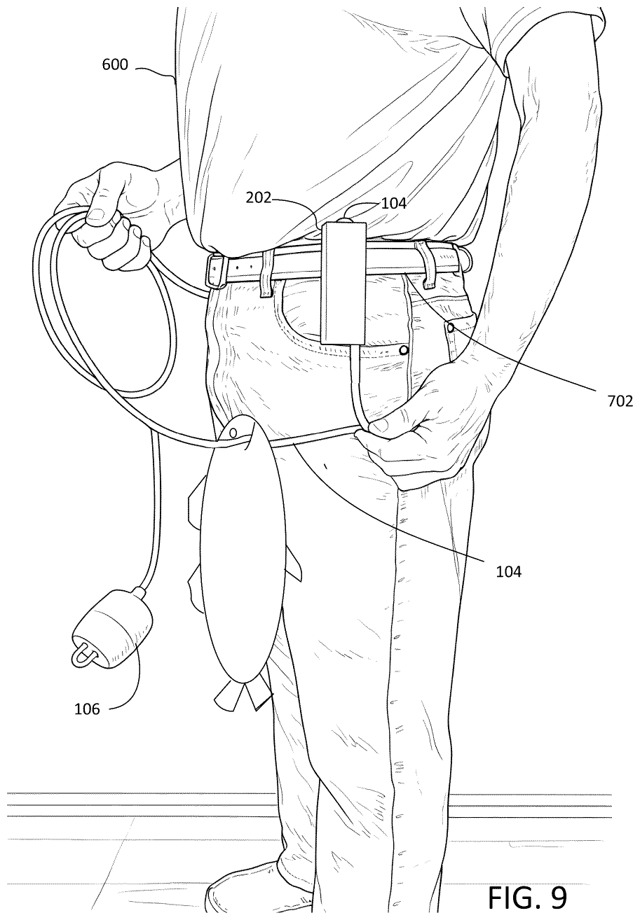

In step 512, the user inserts the needle back into the housing from above into a second channel as shown in FIG. 8. In step 514, as shown in FIG. 9, the user pulls on the string hanging down from the first side of the separator to tighten to secure the needle in the second housing. Because the string passes over the separator, which changes the direction of force, pulling on the string from below pulls the needle up and towards the separator, but the needle is trapped in the housing and so is secured. The rigidity of the needle prevents it from bending and being pulled out of the channel.

In general, a fish stringer clip includes a first section that is open at the top and the bottom for inserting the needle of a fish stringer from the bottom and extracting it at the top. The needle is then inserted into a second section from the top. The first and second sections can overlap, as long as there is a separator that prevents the needle from being pulled out of the second section when the string is pulled from below the first section, either by a user or by the weight of the stringer and attached fish. This diameter of the second section is sufficiently small that the needle cannot be pulled out by pulling on the string from below in the first section. The diameter is smaller than the length of the needle and preferably less than ½ the length of the needle. The housing can include, for example, two cylindrical channels, in which case the material between the opening functions as the separator, or the housing can include a single opening with one or more pins, bolts, or other rods at the top of the fish stringer clip functioning as the separator.

It is preferable that the two sections are identical, so that the user does not need to differentiate between the sections in use and can insert the needle from the bottom of either section. While the channels shown in FIGS. 3-5 do not overlap, the channels could overlap.

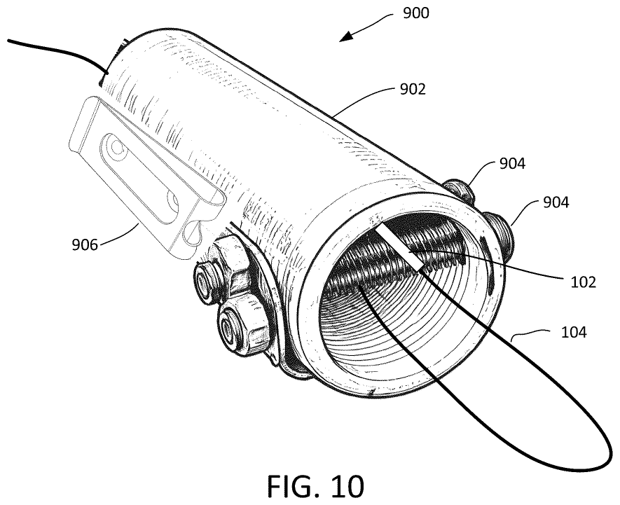

For example, FIG. 10 shows a fish stringer clip 900 that includes a single cylindrical tube 902 having two bolts 904 positioned near a first end of the cylinder 902 and spaced longitudinally along the cylinder axis. The bolts 904 function as a separator. The stringer is inserted from the bottom of the cylindrical tube 902 and exits the top of the cylindrical tube 902 on one side the bolts 904 and then the needle of the stringer is inserted back into the cylindrical tube 902 on the opposite side of the bolts 904. An attachment clip 906 allows the fish stringer clip 900 to be attached to a user's belt or equipment. The separator shown comprises two bolts 904, but any object, such as pins, rods, or sheets, that blocks a needle from moving from one side of the channel to the other can be used as the separator. The separator is not limited to 2 objects, but could comprise 1, 3, or any number of objects that keep the needle on one side or the other of the separator.

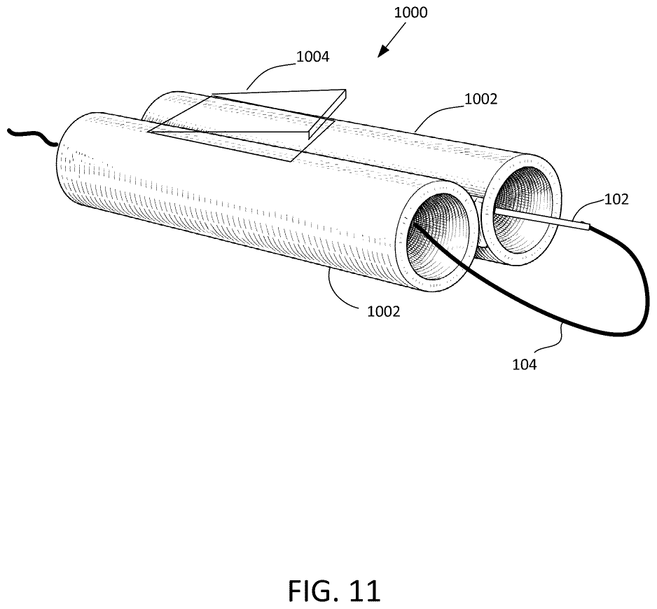

FIG. 11 shows a fish stringer clip 1000 that includes two parallel tubes 1002 attached to each other, for example, by welding, soldering, or adhesive, and a belt clip 1004. Fish stringer 1000 is used in the same manner as fish stringer 200 described above. In the embodiment of FIG. 10, rather than the channels being drilled in a block of material, the channels are defined by the interiors of the connected tubes.

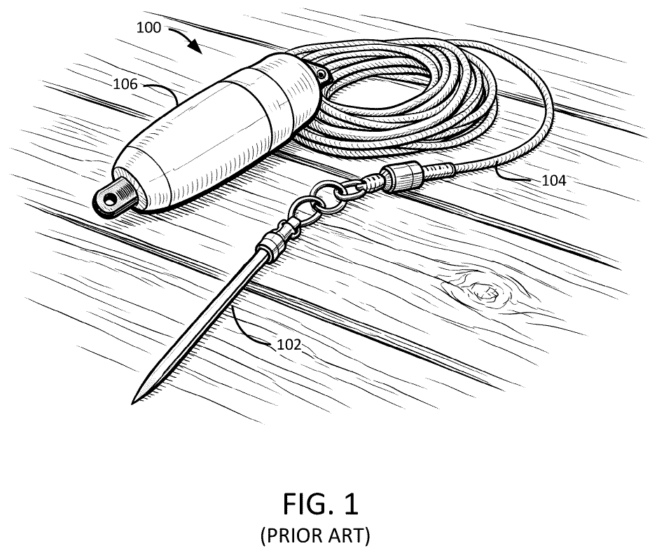

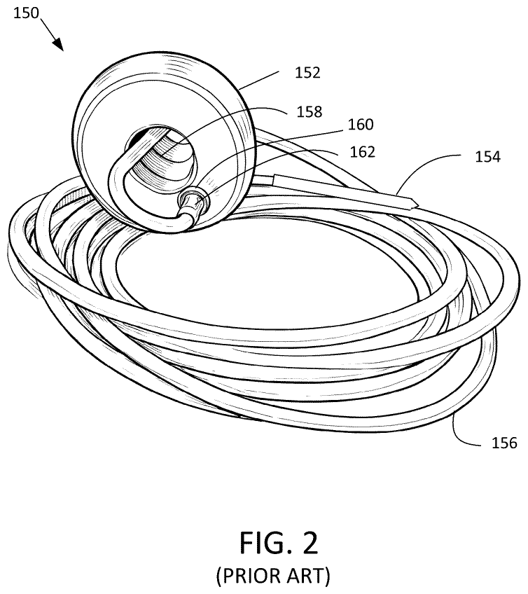

When a fish stringer clip in accordance with this disclosure is used with the fish stringer of FIG. 1 or FIG. 2, any fish on the stringer would be trapped between the float and the fish stringer clip and so the fish are unable to slip off the stringer. In the ForEverlast fish stringer of FIG. 2, the through-hole and blind hole in the float and the second needle are for attaching the float to the string and the needle on the other end is free, like in the stringer of FIG. 1. The float is not a clip to attach the stringer to a user and the float would not serve its function if it were out of the water and attached to the user.

Fish stringers come in different needle and string diameters depending on the type of fish the user anticipates catching. The preferred diameter of the channel will depend on the diameter of the needle and string that the user is using. The diameter of the opening of each channel is sufficiently large to allow the needle to be inserted without requiring undue attention from the user. For example, the diameter may be preferably between 1.05 to 10 times the diameter of the needle. The channel is more preferably between 1.2 times the diameter of the needle and 5 times the diameter of the needle. Cavities typically range in diameter from 0.3″ to 0.8″ with housing ranging in length from 3″ to 6″.

For example, the housing shown in FIGS. 3 and 4 has a length 220 of 4.7″, and the channels have a diameter 222 of 0.5″. These housing dimensions are suitable for a needle size of between 0.2″ and 0.4″. In another example, the housing has a length of 3.5″, and the channels have a diameter of 0.4″. These housing dimensions are suitable for a needle size of between 0.15″ and 0.3″. Following the guidance provided herein, an appropriate length and diameter can be selected for any size fish stringer needle and the fish stringer clip is not limited to any particular size fish stringer clip. The aspect ratio, that is, the length of the channel divided by the diameter is typically between about 2 and 25, more typically between about 3 and 20 or between 5 and 15. Another attachment device, such as a carabiner, can be attached to the housing or to the belt clip for convenience.

Another aspect of the disclosure is a kit that includes a fish stringer clip in accordance with this disclosure and a fish stringer.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure above, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of securing a fish stringer having a string attached to a needle, comprising:
providing a housing having a first channel and a second channel, the first and second channels open at the top and at the bottom and an attachment clip;
securing the attachment clip to a user's clothing or equipment;
passing the needle with the string through the mouth or the gills of a fish to attach the fish to the stringer;
after attaching the fish to the stringer, passing the needle with the string up from the bottom of the first channel and out the top of the first channel;
inserting the needle into the second channel from the top; and
pulling the string extending downward from the first channel, thereby securing the needle in the second channel.

2. The method of claim 1 in which the steps of passing the needle with the string from the bottom of the first channel and out the top of the first channel; inserting the needle into the second channel from the top; and pulling the string extending downward from the first channel are performed with one hand.

3. A fish stringer clip for securing a fish stringer of the type including a string attached to a needle, comprising:
a housing having two channels extending completely through the housing, the diameter of each channel sufficient to fit a needle of a fish stringer; and
an attachment clip attached to the housing for attaching the housing to a user or to a user's equipment, the attachment clip being closed at the top and being held closed at the bottom by tension and having an opening at the top for attachment of a connector opening, the opening extending less than half way to the bottom of the attachment clip, such that a connector attached through the opening at the top cannot slide more than half way toward the bottom, thereby maintaining the center of gravity of the fish stringer clip below the connector, preventing the fish stringer clip from inverting relative user or the user's equipment to when attached to the user or the user's equipment.

4. The fish stringer clip of claim 3 in which the housing comprises a single block of material in which the first and second channels are formed.

5. The fish stringer clip of claim 4 in which the first and second channels are cylindrically shaped and the cylinders have substantially equal diameters.

6. The fish stringer clip of claim 4 in which the first and second channels do not overlap and in which the material between the first and second channels separates the channels.

7. The fish stringer clip of claim 3 in which the housing includes threaded holes for attachment of the attachment clip.

8. The fish stringer clip of claim 3 in which the first and second channels are parallel and do not intersect.

9. The fish stringer clip of claim 8 in which the first and second channels do not overlap.

10. The fish stringer clip of claim 8 in which a separator separates the first and second channels.

11. A kit comprising the fish stringer clip of claim 3 and a fish stringer.

12. The kit of claim 11 in which the channels in the fish stringer clip are between 1.2 and 10 times the diameter of the needle.

13. A fish stringer clip for securing a fish stringer including a rigid needle and a string attached to the needle, comprising:
a housing having an opening therein, the diameter of the opening sufficient to fit a needle of a fish stringer;
a separator within the housing to divide the opening into a first section and a second section, the separator positioned and configured to separate the opening into two sections such that the needle cannot move from one section to the other without being withdrawn from the channel; and
an attachment clip for attaching the fish stringer clip to a user or to a user's equipment.

14. The fish stringer clip of claim 13 in which the opening comprises two non-overlapping cylindrical channels and in which the separator comprises the material between the two channels.

15. The fish stringer clip of claim 13 in which the first section is open to accommodate the needle passing from the bottom through the top of the housing and the second section is open to accommodate the needle being inserted from the top.

16. The fish stringer clip of claim 13 in which the separator comprises a rod extending laterally through the channel.

17. The fish stringer clip of claim 16 in which the rod comprises a pin, a bolt, or a screw.
